(19) United States
(12) Patent Application Publication
(10) Pub. No.: US 2026/0023573 A1
(43) Pub. Date: Jan. 22, 2026

(54) BIOS ASSISTING DEVICE AND BIOS ASSISTING METHOD BASED ON ARTIFICIAL INTELLIGENCE

(71) Applicant: COMPAL ELECTRONICS, INC., Taipei City (TW)

(72) Inventor: Chin-Chia Chang, Taipei City (TW)

(73) Assignee: COMPAL ELECTRONICS, INC., Taipei City (TW)

(21) Appl. No.: 19/245,421

(22) Filed: Jun. 23, 2025

Related U.S. Application Data
(60) Provisional application No. 63/671,768, filed on Jul. 16, 2024.

(51) Int. Cl. G06F 9/4401; G06F 1/3203

(52) U.S. Cl. CPC G06F 9/4406; G06F 1/3203

(57) ABSTRACT

A basic input/output system (BIOS) assisting device and a BIOS assisting method based on artificial intelligence (AI) are provided. The BIOS assisting method includes following steps: receiving a BIOS assisting request through an input/output device; and utilizing an AI module to obtain a BIOS assisting result corresponding to the BIOS assisting request.

### CROSS-REFERENCE TO RELATED APPLICATION

This application claims the priority benefit of U.S. provisional application Ser. No. 63/671,768, filed on Jul. 16, 2024. The entirety of the above-mentioned patent application is hereby incorporated by reference herein and made a part of this specification.

### BACKGROUND

### Technical Field

This disclosure relates to a basic input/output system assisting device and a basic input/output system assisting method based on artificial intelligence.

### Description of Related Art

Currently, when users wish to set options within the basic input/output system (BIOS), the users must first read the operation manual in detail to know the location of this specific option. In particular, for more advanced options, users usually need to search for related information online to learn how to set them. For users, this approach is overly complex and inconvenient.

### SUMMARY

A basic input/output system (BIOS) assisting device based on artificial intelligence (AI) of the disclosure includes a storage medium, an input/output device, a BIOS, and a processor. The BIOS has a built-in AI module. The processor is coupled to the storage medium, the input/output device, and the BIOS. The processor receives a BIOS assisting request through the input/output device. The processor utilizes the AI module to obtain a BIOS assisting result corresponding to the BIOS assisting request.

A BIOS assisting method based on AI of the disclosure is configured for a BIOS assisting device including a storage medium, an input/output device, a BIOS, and a processor. The BIOS has a built-in AI module. The BIOS assisting method includes the following steps. A BIOS assisting request is received through the input/output device. The AI module is utilized to obtain a BIOS assisting result corresponding to the BIOS assisting request.

Based on the above, the BIOS assisting device and the BIOS assisting method based on AI of the disclosure may receive a BIOS assisting request from users, and utilize the AI module to obtain a BIOS assisting result corresponding to the BIOS assisting request. For users, the disclosure significantly improves the convenience of the BIOS setting.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram illustrating a basic input/output system (BIOS) assisting device based on artificial intelligence (AI) according to an embodiment of the disclosure.

FIG. 2 is a flowchart illustrating a BIOS assisting method based on AI according to an embodiment of the disclosure.

FIG. 3 is an example of a setup interface mode of the BIOS assisting device shown in FIG. 1.

FIG. 4 is an operating example of the BIOS assisting device shown in FIG. 1 based on a local large language model (LLM) under the Unified Extensible Firmware Interface (UEFI) standard.

FIG. 5 is an operating example of the BIOS assisting device shown in FIG. 1 based on a Domain-Specific Language Model (DSLM) under the UEFI standard.

### DESCRIPTION OF THE EMBODIMENTS

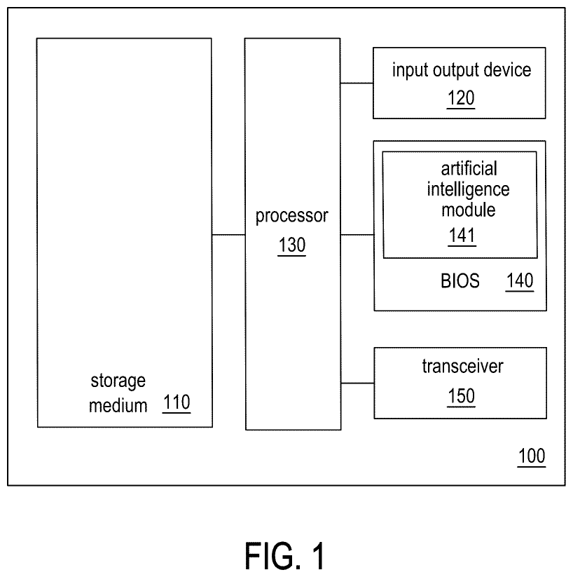

FIG. 1 is a schematic diagram illustrating a basic input/output system (BIOS) assisting device 100 based on artificial intelligence (AI) according to an embodiment of the disclosure. The BIOS assisting device 100 may include a storage medium 110, an input/output device 120, a BIOS 140, and a processor 130. The processor 130 may be coupled to the storage medium 110, the input/output device 120, and the BIOS 140. In this embodiment, the BIOS 140 may have a built-in AI module 141, and the BIOS 140 may be embedded in a BIOS chip (not shown). More specifically, the BIOS 140 is a firmware responsible for hardware initialization and basic setting when the BIOS assisting device 100 is powered on, wherein the BIOS 140 having the built-in AI module 141 means that the AI module 141 is programmed and embedded in the BIOS 140 as a part of the BIOS 140. In an embodiment, the BIOS assisting device 100 may include a transceiver 150 coupled to the processor 130.

The storage medium 110 is, for example, any type of fixed or removable random access memory (RAM), read-only memory (ROM), flash memory, hard disk drive (HDD), solid state drive (SSD), or similar components or a combination of the above components, and is used to store multiple modules or various application programs that may be executed by the processor 130.

The input/output device 120 may include various input/output devices such as a mouse, keyboard, screen, touch panel, and/or speaker.

The processor 130 is, for example, a central processing unit (CPU), or other programmable general-purpose or special-purpose micro control unit (MCU), microprocessor, digital signal processor (DSP), programmable controller, application specific integrated circuit (ASIC), graphics processing unit (GPU), image signal processor (ISP), image processing unit (IPU), arithmetic logic unit (ALU), complex programmable logic device (CPLD), field programmable gate array (FPGA), or other similar components or a combination of the above components.

The transceiver 150 may transmit and receive signals via wireless or wired connections.

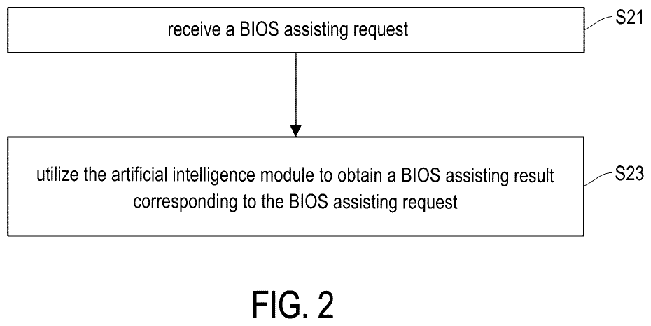

FIG. 2 is a flowchart illustrating a BIOS assisting method based on AI according to an embodiment of the disclosure, wherein the BIOS assisting method may be implemented by the BIOS assisting device 100 shown in FIG. 1. Please refer to FIG. 1 and FIG. 2 simultaneously.

In step S21, the processor 130 may receive a BIOS assisting request through the input/output device 120. In other words, the users may utilize the input/output device 120 to input the BIOS assisting request to the BIOS assisting device 100.

In step S23, the processor 130 may utilize the AI module 141 to obtain a BIOS assisting result corresponding to the BIOS assisting request.

In an embodiment, the processor 130 may output the BIOS assisting result through the input/output device 120.

In an embodiment, the processor 130 may utilize the BIOS assisting result to set the BIOS 140.

In an embodiment, the BIOS assisting device 100 may be operated in a setup interface mode. It should be noted that the setup interface mode is, for example, an interactive window or interactive interface activated by the users operating the input/output device 120 during the powered-on process of the BIOS assisting device 100, or within the setup menu of the BIOS assisting device 100.

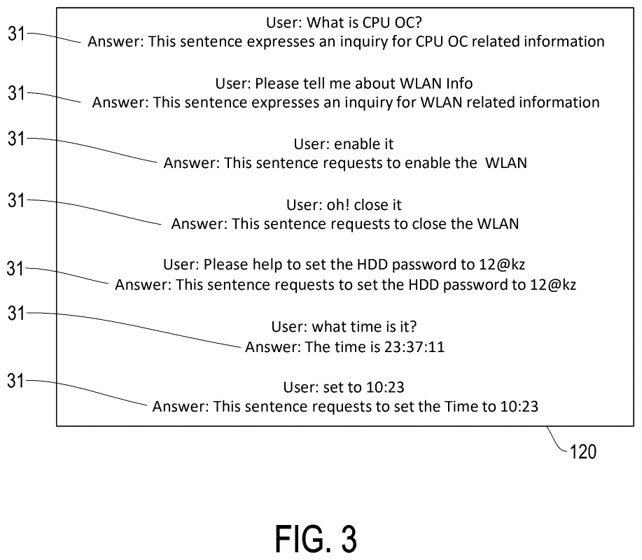

FIG. 3 is an example of a setup interface mode of the BIOS assisting device 100 shown in FIG. 1. Please refer to FIG. 1, FIG. 2, and FIG. 3 simultaneously. For example, taking the Unified Extensible Firmware Interface (UEFI) standard as an example, the AI module 141 may be implemented in the driver execution environment (DXE) stage of the UEFI standard. Then the BIOS assisting device 100 may display the setup interface as shown in FIG. 3 through the input/output device 120 in the Boot Device Select (BDS) stage of the UEFI standard or in the setup menu. As shown in FIG. 3, the processor 130 may output a BIOS assisting result 31 through the input/output device 120. Furthermore, the processor 130 may also utilize the BIOS assisting result 31 to set the BIOS 140. In other words, the BIOS assisting device 100 of the disclosure may allow the users to utilize natural language to inquire information related to the BIOS 140, or may allow the users to utilize natural language to set options within the BIOS 140. This may provide convenience for the users. It should be noted that in the setup interface mode of the BIOS assisting device 100 shown in FIG. 3, although the BIOS assisting device 100 has not entered an operating system (OS) mode, the BIOS assisting device 100 of the disclosure may still utilize the AI module 141 to obtain the BIOS assisting result corresponding to the BIOS assisting request.

In one embodiment, the BIOS assisting device 100 may be operated in the OS mode. The processor 130 may set the BIOS 140 through an operating system power management hardware configuration interface. In one embodiment, the operating system power management hardware configuration interface may include Windows Management Instrumentation (WMI) and Advanced Configuration and Power Interface (ACPI). In detail, for more advanced options of the BIOS 140 that need to be set in the OS mode, the processor 130 may set these options of the BIOS 140 through the operating system power management hardware configuration interface. For example, when the BIOS assisting device 100 is operated in the OS mode, the BIOS assisting device 100 may set the BIOS 140 through the operating system power management hardware configuration interface in the Run Time (RT) stage of the UEFI standard.

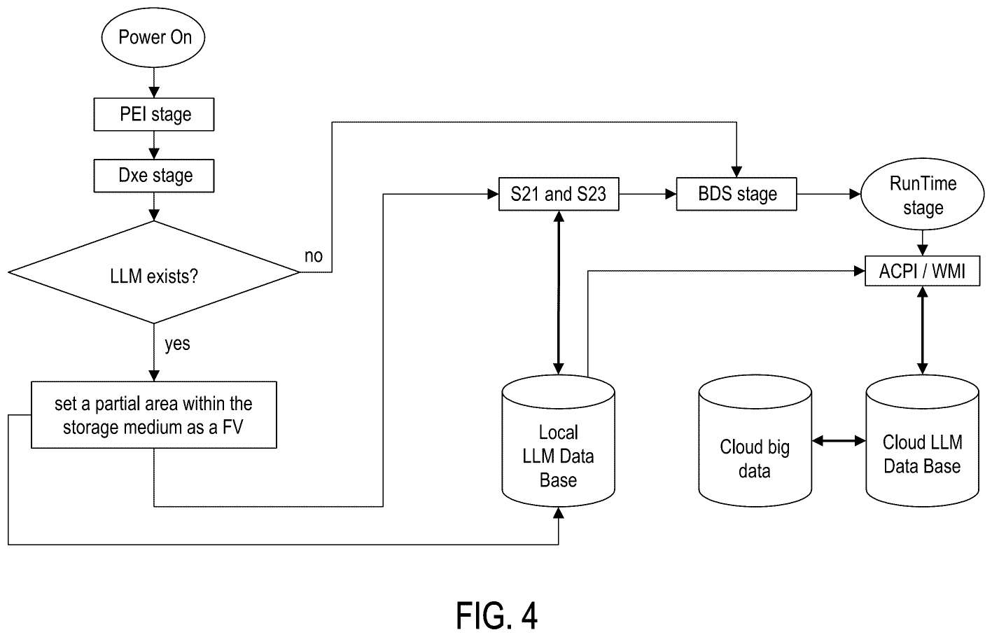

FIG. 4 is an operating example of the BIOS assisting device 100 shown in FIG. 1 based on a local Large Language Model (LLM) under the UEFI standard. Please refer to FIG. 1, FIG. 2 and FIG. 4 simultaneously. In this embodiment, the AI module 141 may include a local LLM. On the other hand, the storage medium 110 may store a database of the local LLM. Specifically, as shown in FIG. 4, when the BIOS assisting device 100 is powered on, it first enters the PEI (Pre-EFI Initialization) stage. Then, in the DXE stage, the processor 130 may determine whether a local LLM exists in the AI module 141. When the processor 130 determines that a local LLM exists in the AI module 141, the processor 130 may designate a partial area within the storage medium 110 as a Firmware Volume (FV). In other words, when the processor 130 determines that a local LLM exists in the AI module 141, the processor 130 may load the local LLM in the DXE stage, and the processor 130 may designate the area within the storage medium 110 that “stores the database of the local LLM” as a firmware volume for the local LLM to use. Then, the processor 130 may perform step S21 of FIG. 2. Subsequently, the processor 130 may perform step S23 of FIG. 2 to utilize the local LLM in the AI module 141 to obtain a BIOS assisting result corresponding to the BIOS assisting request. In detail, the processor 130 may search the firmware volume according to the BIOS assisting request to obtain the BIOS assisting result. Then, the processor 130 may utilize the BIOS assisting result to set the BIOS 140. Furthermore, the processor 130 may obtain a setting result after setting the BIOS 140. Subsequently, the processor 130 may utilize the setting result to update the local LLM. Then, after the BIOS assisting device 100 completes the Boot Device Selection (BDS) stage and enters the Run Time (RT) stage, the processor 130 may transmit the setting result to a cloud LLM through the transceiver 150. For example, the processor 130 may transmit the setting result to the cloud LLM based on WMI and ACPI. Based on this, the cloud LLM may utilize the setting result to perform big data analysis, thereby optimizing the cloud LLM.

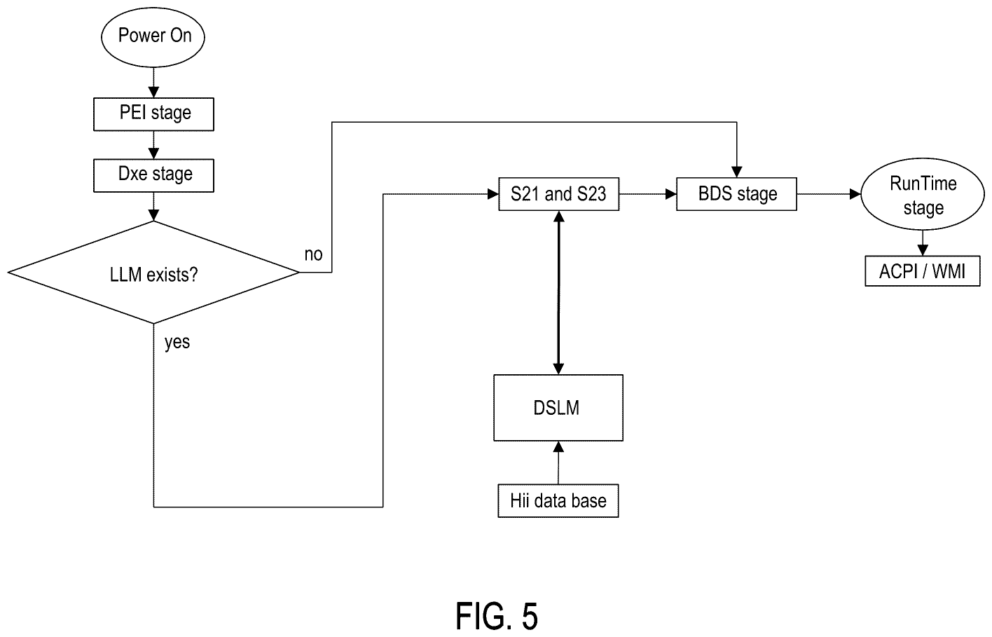

FIG. 5 is an operating example of the BIOS assisting device 100 shown in FIG. 1 based on a Domain-Specific Language Model (DSLM) under UEFI standard. Please refer to FIG. 1, FIG. 2 and FIG. 5 simultaneously. In this embodiment, the AI module 141 may include a DSLM. On the other hand, the storage medium 110 may store a DSLM database. The DSLM database may be a database of UEFI standard, for example, Hii (Human Interface Information) database. Specifically, as shown in FIG. 5, when the BIOS assisting device 100 is powered on, the processor 130 may determine whether a DSLM exists in the AI module 141. When the processor 130 confirms that a DSLM exists in the AI module 141, the processor 130 may perform step S21 of FIG. 2. Subsequently, the processor 130 may perform step S23 of FIG. 2 to utilize the DSLM in the AI module 141 to obtain a BIOS assisting result corresponding to the BIOS assisting request. Then, the processor 130 may utilize the BIOS assisting result to set the BIOS 140.

In summary, the AI-based BIOS assisting device and method of the disclosure may receive a BIOS assisting request from users, and utilize an AI module to obtain a BIOS assisting result corresponding to the BIOS assisting request. In addition, the BIOS assisting result may be output or used to directly set the BIOS. For users, the disclosure significantly improves the convenience of the BIOS setting.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A basic input/output system (BIOS) assisting device based on artificial intelligence (AI), comprising:
a storage medium;
an input/output device;
a BIOS with a built-in AI module; and
a processor, coupled to the storage medium, the input/output device, and the BIOS, wherein
the processor receives a BIOS assisting request through the input/output device;
the processor utilizes the AI module to obtain a BIOS assisting result corresponding to the BIOS assisting request.

2. The BIOS assisting device according to claim 1, wherein
the processor outputs the BIOS assisting result through the input/output device.

3. The BIOS assisting device according to claim 1, wherein
the processor utilizes the BIOS assisting result to set the BIOS.

4. The BIOS assisting device according to claim 1, wherein the BIOS assisting device is operated in a setup interface mode.

5. The BIOS assisting device according to claim 1, wherein the BIOS assisting device is operated in an operating system (OS) mode, wherein the processor sets the BIOS through an operating system power management hardware configuration interface.

6. The BIOS assisting device according to claim 5, wherein the operating system power management hardware configuration interface comprises Windows Management Instrumentation (WMI) and Advanced Configuration and Power Interface (ACPI).

7. The BIOS assisting device according to claim 5, further comprising a transceiver coupled to the processor, wherein the AI module includes a local large language model (LLM), wherein
the processor obtains a setting result after setting the BIOS;
the processor utilizes the setting result to update the local LLM;
the processor is configured to transmit the setting result to a cloud LLM through the transceiver.

8. The BIOS assisting device according to claim 1, wherein the AI module includes a Domain-Specific Language Model (DSLM).

9. The BIOS assisting device according to claim 1, wherein
when the BIOS assisting device is powered on, the processor determines whether a local LLM exists in the AI module;
when the processor determines that the local LLM exists in the AI module, the processor sets a partial area of the storage medium as a Firmware Volume (FV).

10. A basic input/output system (BIOS) assisting method based on artificial intelligence (AI), configured for a BIOS assisting device comprising a storage medium, an input/output device, a BIOS, and a processor, wherein the BIOS has a built-in AI module, wherein the BIOS assisting method comprises:
receiving a BIOS assisting request through the input/output device; and
utilizing the AI module to obtain a BIOS assisting result corresponding to the BIOS assisting request.

11. The BIOS assisting method according to claim 10, further comprising:
outputting the BIOS assisting result through the input/output device.

12. The BIOS assisting method according to claim 10, further comprising:
utilizing the BIOS assisting result to set the BIOS.

13. The BIOS assisting method according to claim 10, wherein the BIOS assisting device is operated in a setup interface mode.

14. The BIOS assisting method according to claim 10, wherein the BIOS assisting device is operated in an operating system (OS) mode, wherein the BIOS assisting method further comprises:
setting the BIOS through an operating system power management hardware configuration interface.

15. The BIOS assisting method according to claim 14, wherein the operating system power management hardware configuration interface comprises Windows Management Instrumentation (WMI) and Advanced Configuration and Power Interface (ACPI).

16. The BIOS assisting method according to claim 14, wherein the BIOS assisting device further includes a transceiver, wherein the AI module includes a local large language model (LLM), wherein the BIOS assisting method further comprises:
obtaining a setting result after setting the BIOS;
utilizing the setting result to update the local LLM; and
transmitting the setting result to a cloud LLM through the transceiver.

17. The BIOS assisting method according to claim 10, wherein the AI module includes a Domain-Specific Language Model (DSLM).

18. The BIOS assisting method according to claim 10, wherein the BIOS assisting method further comprises:
when the BIOS assisting device is powered on, determining whether a local LLM exists in the AI module; and
when the local LLM exists in the AI module, designating a partial area of the storage medium as a Firmware Volume (FV).
